(19) United States
(12) Patent Application Publication
(10) Pub. No.: US 2006/0096790 A1
(43) Pub. Date: May 11, 2006

(54) Compact weighing system

(75) Inventors: Sigo Muehlich, Bovenden (DE); Otto Kuhlmann, Goettingen (DE); Peter Fleischer, Goettingen (DE)

Correspondence Address: SUGHRUE MION, PLLC, 2100 PENNSYLVANIA AVENUE, N.W., SUITE 800, WASHINGTON, DC, 20037, US

(73) Assignee: SARTORIUS AG

(21) Appl. No.: 11/298,699

(22) Filed: Dec. 12, 2005

Related U.S. Application Data
(63) Continuation of application No. PCT/EP04/06287, filed on Jun. 11, 2004.

(30) Foreign Application Priority Data
Jun. 13, 2003 (DE) 103 26 699.2

(51) Int. Cl. G01G 7/02

(52) U.S. Cl. 177/210 EM; 177/229; 177/212

(57) ABSTRACT

A weighing system having a top pan balance with a divided upper guide (3a/3b) and a divided lower guide (4a, 4b) which cooperate to give a parallel guide, and link a load sensor (5) with a system support (2) that is mounted on the housing in a fixed manner. The weighing system has a translation lever which is rotatably mounted on the system support (2) by means of two flectors, the translation lever divided into two secondary levers (8a, 8b). Additionally, the weighing system includes a coupling element which is linked with the load sensor (5) and with a short lever arm of the translation lever. Flectors (7a, 7b) receiving the two secondary levers (8a,8b) are arranged adjacent the load sensor (5) and the rotational axis defined by the flectors (7a, 7b) extends through the load sensor (5).

### CROSS-REFERENCE TO RELATED APPLICATIONS

This is a Continuation of International Application PCT/EP2004/006287, with an international filing date of Jun. 11, 2004, which was published under PCT Article 21(2) in German, and the disclosure of which is incorporated into this application by reference.

### BACKGROUND OF THE INVENTION

1. Field of the Invention

The invention relates to a weighing system for a top pan balance based on the principle of electromagnetic force compensation. More particularly, the invention relates to a weighing system that can be made compact by including a translation lever that is divided into two secondary levers, each of the secondary levers mounted for rotation on a system support by respective flectors, wherein the flectors are arranged adjacent to a load sensor, such that a rotational axis defined by the flectors extends through the load sensor.

2. Description of the Related Art

A weighing system known in the related art has a divided upper guide and a divided lower guide which cooperate to form a parallel guide and link a load sensor with a system support fixed to the housing. The weighing system further has a translation lever, which is mounted for rotation on the system support by means of two flectors, and a coupling element linked by the flectors to the load sensor on the one hand and the short lever arm of the translation lever on the other. The system support, the load sensor, the guides, the translation lever, the two flectors for mounting the translation lever, and the coupling element form a one-piece base.

The weighing system further has a magnet mounted in the clearance between the parts of the guides and a coil that is fixed to a longer lever arm of the translation lever and extends into the air gap of the magnet. In this configuration, the force corresponding to the mass of a material being weighed is transmitted from the load sensor to a short lever arm of the translation lever via the coupling element and is compensated there by the counterforce of the coil through which a current flows on the longer lever arm.

A weighing system of this type is disclosed in the German Publication DE 44 27 087 C2.

One disadvantage of this related art weighing system is its relatively large structural shape, because it needs a correspondingly large housing for installation in a balance, and because the one-piece base requires a large amount of material and machining during production.

It is also known in the related art to partially divide the translation lever as disclosed in German publications DE 37 43 073 A1 and DE 199 23 208 C1 for the particular reasons disclosed in these publications. However, in both of these publications, which are hereby incorporated into the present application by reference, the division is only partial. Furthermore, the load sensor, the translation lever and the magnet are arranged one behind the other, preventing a compact design.

### SUMMARY OF THE INVENTION

Illustrative, non-limiting embodiments of the present invention are described below. One object of the present invention is to provide a structural shape for a balance which is compact and cost effective to manufacture.

According to one formulation of the invention, the translation lever is divided into two secondary levers, each mounted for rotation on the system support by means of a flector. The coupling element is likewise divided into two secondary coupling elements. The flectors used to mount the two secondary levers of the translation lever on the system support are arranged adjacent the load sensor, and the rotational axis defined by the flectors extends through the load sensor.

By dividing the translation lever into two, separate secondary levers, the two secondary levers can be placed laterally adjacent the magnet. The arrangement of the flector supports for the translation lever in an axial direction adjacent the load sensor makes it possible to arrange the load sensor close to the magnet, so that all the mechanical parts of the weighing system are placed directly around the magnet to form a highly compact weighing system.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of the weighing system from the front/side of an exemplary embodiment of the present invention,

FIG. 2 is a perspective view of the weighing system from the rear/side, and

FIG. 3 is a side view of the weighing system.

### DETAILED DESCRIPTION OF EXEMPLARY EMBODIMENTS OF THE INVENTION

The present invention will now be described more fully with reference to the accompanying drawings, in which exemplary embodiments of the invention are shown.

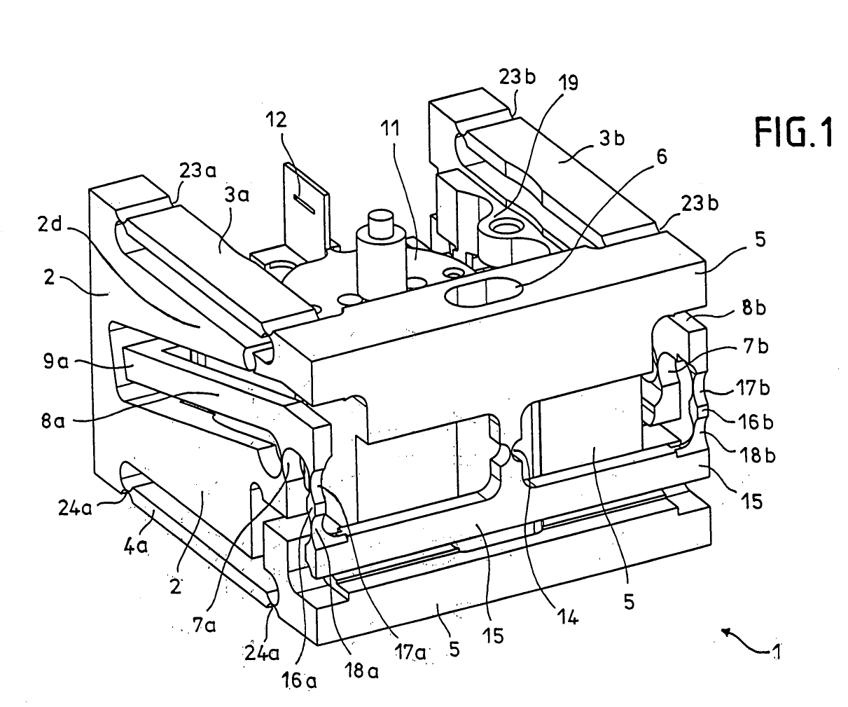

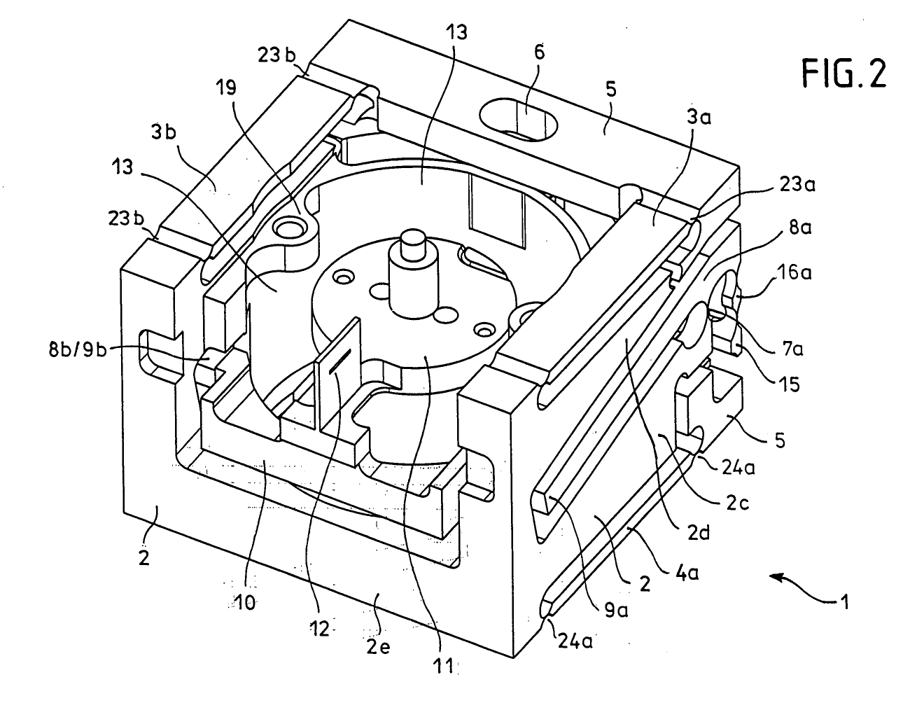

FIGS. 1 through 3 show the one-piece base 1 of a weighing system of an exemplary embodiment of the present invention. The weighing system consists of a system support 2 fixed to the housing of the balance (not shown), with which a load sensor 5 is connected for vertical movement via a divided upper guide 3a/3b and a divided lower guide 4a/4b (part 4b is hidden in the Figures). The flectors at the ends of the divided guides are identified as 23a, 23b and 24a, respectively. The load sensor 5 has a recess 6 for mounting a pan (not depicted). A first secondary lever 8a is furthermore mounted for rotation on the system support 2 via a flector 7a. Symmetrically thereto, a second secondary lever 8b (only a portion of which is visible in FIGS. 1 and 2) is mounted via a flector 7b. The two secondary levers 8a and 8b are interconnected by a cross member 10 at the respective end 9a and 9b of their longer lever arm (FIG. 2). This cross member 10 carries a coil support 11 for the electromagnetic force compensation coil and a slit aperture 12 as the position sensor. The magnet, into the air gap of which the coil dips, is not shown. During assembly, the magnet is inserted into the cylindrical clearance formed by the wall 13 from the bottom and is screwed to the protruding limit stops 19. The interaction in electromagnetic force compensation of the position sensor, the coil, and the magnet is generally known to those of ordinary skill in the art, so it is not described it in detail here.

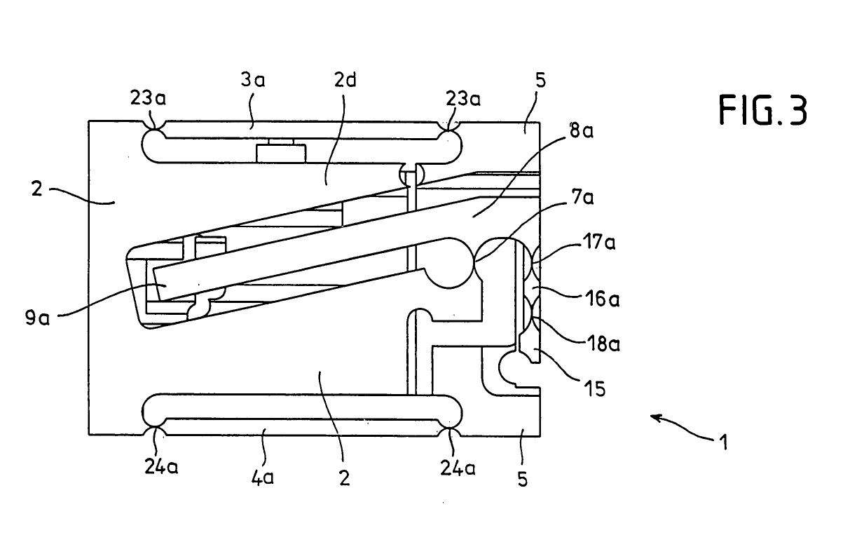

The two flectors 7a and 7b of the two secondary levers 8a and 8b are located axially adjacent the load sensor 5. The term “axially adjacent the load sensor” means, in an exemplary embodiment, that the connecting line between the two flectors and hence the rotational axis defined by the two flectors passes through the load sensor 5. With this arrangement of the essential areas of the load sensor between the flectors 7a and 7b, the load sensor does not increase the length (i.e., the left/right extension in the representation of FIG. 3) of the weighing system. Thus, dividing the translation lever into two secondary levers and arranging the magnets and the load sensor therebetween makes it possible to achieve a highly compact design.

The load sensor 5 transmits the force corresponding to the mass of the material being weighed to an intermediate cross member 15 via a flector 14. Two secondary coupling elements 16a and 16b are coupled at the two ends of the intermediate cross member 15 to transmit the force to the short lever arms of the secondary levers 8a and 8b. The flectors between the secondary coupling elements 16a and 16b and the secondary levers 8a and 8b are identified as 17a and 17b, the flectors between the secondary coupling elements 16a and 16b and the intermediate cross member 15 as 18a and 18b. The flector 14 between the load sensor 5 and the intermediate cross member 15 lies in the plane of symmetry of the weighing system. Flector 14's rotational axis also lies in the plane of symmetry. This flector arrangement has the effect that the tilting moments acting on the load sensor are absorbed by the guides 3a/3b and 4a/4b and are transmitted as little as possible to the two secondary coupling elements 16a and 16b.

The two secondary coupling elements 16a and 16b are located on the right side of the load sensor 5 as seen in FIG. 3 and thus, on the side of the load sensor 5 opposite the magnet. This makes almost the full length of the weighing system available for the length of the secondary lever of the translation lever. As a result, a maximum translation ratio—the distance between the flectors 7a and 17a—is obtained for a given short lever arm.

As may be seen in FIG. 2, the system support forms a closed frame around the magnet. The wall 13 is connected to the areas 2c and 2d of the system support 2 and forms the circumferential frame together with the cross connection 2e. This provides high torsional stiffness of the system support and thus excellent stability against external forces and moments. The oblique arrangement of the secondary levers of the translation lever also contributes to this. That is, since the short lever arm of the secondary levers 8a and 8b must extend in the upper area of the weighing system to provide sufficient length of the secondary coupling elements 16a and 16b, a horizontal extension of the secondary levers of the translation lever would result in a very narrow and thus, not very stable area 2d of the system support. The oblique extension provides stability in this area 2d. Although this measure may weaken the area 2c, this is not problematic because the area 2c is very stable by nature, particularly because of the cross connection 2e.

The above-described arrangement of the secondary levers 8a and 8b of the translation lever at the side of the base 1 has the result that the flectors 7a and 7b and the flectors 17a, 17b, 18a, 18b of the secondary coupling elements are also arranged at the lateral edge of the base. The secondary guides 3a and 3b and 4a and 4b and their flectors at the ends are likewise arranged at the lateral edge of the base. All of these flectors can therefore be machined using very short milling cutters during production. Warping, which occurs when long milling cutters are used for machining, is therefore minimized here, such that the flectors can be manufactured with small tolerances. The flector 14 is also readily accessible and can likewise be produced using a short milling cutter. If the milling cutters are short, it is also possible to use thinner milling cutters. This makes it possible, for example, to shorten the distance between the flectors 7a/7b and 17a/17b. Hence the short lever arm of the secondary levers of the translation lever can be shortened and the translation ratio can thereby be increased.

In other words, this advantageous, production friendly configuration is characterized in that the secondary guides 3a and 4a and their flectors 23a and 24a, the one secondary lever 8a and its flector 7a and the one secondary coupling element 16a and its flectors 17a and 18a are arranged in a first vertical plane. The secondary guides 3b and 4b and their flectors 23b and 24b, the other secondary lever 8b and its flector 7b and the other secondary coupling element 16b and its flectors 17b and 18b are arranged in a second vertical plane. The two planes extend adjacent the magnet at a distance from each other parallel to the vertical axis of symmetry of the weighing system.

The above description of exemplary embodiments has been given by way of example. From the disclosure given, those skilled in the art will not only understand the present invention and its attendant advantages, but will also find apparent various changes and modifications to the structures disclosed. It is sought, therefore, to cover all such changes and modifications as fall within the spirit and scope of the invention, as defined by the appended claims, and equivalents thereof.

What is claimed is:

1. A weighing system for a top pan balance comprising:
a load sensor;
a system support; and
a translation lever divided into two secondary levers, each of the secondary levers mounted for rotation on the system support by a respective flector,
wherein the flectors are arranged adjacent to the load sensor, and a rotational axis defined by the flectors extends through the load sensor.

2. The weighing system as claimed in claim 1, further comprising a coupling element divided into two secondary coupling elements, having respective flectors, the coupling element linked to the load sensor and to a short lever arm of the translation lever, and wherein a force of a mass of material weighed is transmitted by the load sensor to the short lever arm via the coupling element.

3. The weighing system as claimed in claim 1, further comprising:
a plurality of secondary guides, one of the secondary guides having respective flectors, wherein the one secondary lever with its flector and the one secondary coupling element with its flectors are arranged in a first vertical plane, and
another of the secondary guides having respective flectors, the secondary lever with its flector, and the other secondary coupling element with its flectors are arranged in a second vertical plane, and the first and second vertical planes extend adjacent a magnet at a distance from each other parallel to a vertical plane of symmetry of the weighing system.

4. The weighing system as claimed in claim 2, further comprising an intermediate cross member, wherein the intermediate cross member transmits the force from the load sensor to the two secondary coupling elements, and the intermediate cross member is linked to the load sensor by a flector which is arranged in the plane of symmetry of the weighing system and the rotational axis of which lies in the plane of symmetry of the weighing system.

5. The weighing system as claimed in claim 1, wherein the two secondary levers of the translation lever are interconnected by a cross member on the side of a magnet opposite the load sensor.

6. The weighing system as claimed in claim 4, further comprising a coil, wherein the coil is fixed to the cross member by a coil support.

7. The weighing system as claimed in claim 1, wherein the system support forms a closed frame around a magnet.

8. The weighing system as claimed in claim 1, wherein the two secondary levers of the translation lever extend at an angle to the horizontal.

9. The weighing system as claimed in claim 1, further comprising a parallel guide having a divided upper guide and a divided lower guide, the parallel guide linking a load sensor to the system support.

10. The weighing system as claimed in claim 9, further comprising a magnet mounted in a clearance formed by the divided upper guide and the divided lower guide.

11. The weighing system as claimed in claim 2, wherein the system support, the load sensor, the translation lever, the coupling element, and upper and lower guides form a one-piece base.

12. The weighing system as claimed in claim 2, further comprising a coil fixed to a longer lever arm of the translation lever.
